(19) United States
(12) Patent Application Publication
(10) Pub. No.: US 2026/0244675 A1
(43) Pub. Date: Aug. 20, 2026

(54) LARGE LANGUAGE MODEL-BASED PROCESSES FOR AUGMENTING/CREATING ONTOLOGY NODES

(71) Applicant: Dell Products L.P., Round Rock, TX (US)

(72) Inventors: Ibrahim Abu Alhaol, Nepean (CA); Mustafa Al-Bado, Cork (IE); Said Tabet, Austin, TX (US); Gwenael Poitau, Montreal (CA)

(21) Appl. No.: 19/056,042

(22) Filed: Feb. 18, 2025

(51) Int. Cl. G06F 16/36

(52) U.S. Cl. CPC G06F 16/367

(57) ABSTRACT

Creating and/or augmenting ontology nodes is disclosed. A triple from a source document is received at a relation creation system. Based on the triple, corresponding subject and object nodes are created if necessary. The predicate in the triple is evaluated to determine whether the subject node and the object node should be related. Finally, the relationship, which may include the subject node, the relation, and/or the object node, are validated by a context validation engine. Once validated, the relationship may be optimized and included in a node database or ontology.

### TECHNOLOGICAL FIELD OF THE DISCLOSURE

Embodiments disclosed herein generally relate to structures that store data and to managing the structures. More particularly, at least some embodiments relate to systems, hardware, software, computer-readable media, and methods for managing an ontology, which includes augmenting and/or creating ontology nodes in an ontology.

### BACKGROUND

A variety of tools exist for using and managing data. Large language models (LLMs) are examples of artificial intelligence systems that are capable of interpreting and producing text that closely resembles natural human language. LLMs have broad applicability in various fields and are particularly useful in applications that depend on language analysis and language generation.

LLMs may use various data sources for generating responses to a query. Examples of the sources may include graphs of various types including knowledge graphs and ontologies. A knowledge graph, for example, is a graphical representation of knowledge and may illustrate how different concepts, entities, and events interconnect. Knowledge graphs allow large amount of data to be navigated and provide insights into how various pieces of data are interrelated. Knowledge graphs are often used in applications such as semantic web services, data integration, and artificial intelligence.

Another example of a data source is an ontology. While an ontology has various similarities to a knowledge graph, an ontology is a formal representation of knowledge as a set of concepts withing a domain and the relationships between those concepts.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A discloses aspects of extracting text, including ontology triples, from an input source;

FIG. 1B discloses aspects of extracting text from an input source;

FIG. 2A discloses aspects of a system for creating and/or augmenting a node database or an ontology;

FIG. 2B-2C discloses aspects of examples for creating and/or augmenting a node database or an ontology;

FIG. 3 discloses aspects of a method for creating and/or augmenting a node database or an ontology; and

FIG. 4 discloses aspects of a computing device, a computing system, or computing entity.

### DETAILED DESCRIPTION OF SOME EXAMPLE EMBODIMENTS

Embodiments disclosed herein generally relate to ontology management. More particularly, at least some embodiments relate to systems, hardware, software, computer-readable media, and methods for managing ontologies, which may include creating and/or augmenting nodes (e.g., entries) in an ontology.

Embodiments of the invention relate to ontologies and are discussed in the context of web ontology language (OWL) and resource description framework (RDF). Embodiments of the invention are further discussed in the context of ontologies that are constructed using triples. Embodiments of the invention, however, are not limited to these languages, frameworks, and methods of ontology construction. Other frameworks may include relational models, taxonomic hierarchies, or the like. The type of ontology selected for a given purpose may depend on the domain of the ontology. In addition, embodiments of the invention may be adapted to managing other structures such as linked structures, knowledge graphs, network graphs, and the like.

Generally, an ontology may be represented as a graph using nodes and edges. The nodes of an ontology may represent, by way of example only and not limitation, classes and instances. Classes may represent the categories of a domain while instances may be specific examples of a class. Relationships (e.g., edges) may define how classes are related to each other. Classes and instances may be associated with attributes, which may relate to properties or characteristics of a class or instance. An ontology may also be associated with rules that may determine or define how classes, instances, and relationships interact.

An ontology is often constructed using building blocks such as triples. OWL and RDF are examples of web technologies that employ triples. A triple (e.g., subject, predicate, and object) is used to define or describe knowledge in an ontology. By way of example, the subject may be the class being described, the object may be the value or instance associated with the subject via the predicate, which describes the relationship of the subject to the object. Some objects are, more specifically, literals.

RDF is an example of a formal structure that may be used within a domain of knowledge. RDF is often used as a framework to represent data on the web.

For example, a triple may be expressed in natural language as follows:
Arizona (subject) includes a city (predicate) Phoenix (object).

In RDF, this triple may be expressed as follows:
http://example.org/arizona, http://example.org/includescity
http://example.org/Phoenix.

In this example, each part of the triple is identified by a URL (Uniform Resource Locator). Triples may be used, by way of example only, to describe class hierarchies (e.g., city is a subclass of State), attributes (e.g., city has a population of number), and relationships between entities (e.g., cities require water). A web ontology language (OWL) ontology is another example that may be used to represent, define, and/or store knowledge within a specific domain.

An ontology, as previously stated, is often represented by nodes and connections or relationships. However, creating nodes is a challenging task. Ontologies often represent extensive volumes of data with intricate relational structures. The complexity of ontology management is evident in the task of ensuring uniformity while minimizing human errors and biases and in the task of integrating new information to adapt to the ever-shifting landscape of the ontology's domain. These tasks are further complicated by the need for accuracy, rigorous validation and the need to interact with a variety of data sources.

Embodiments of the invention relate to creating and/or augmenting entries (e.g., subject nodes, object nodes, and/or relationships) in an ontology. In one example, a node database may store nodes of an ontology or store the ontology. Embodiments of the invention may retrieve triples from a set of extracted text and perform management operations including node creation operations, node augmentation operations, or the like based on the triples included in the extracted text.

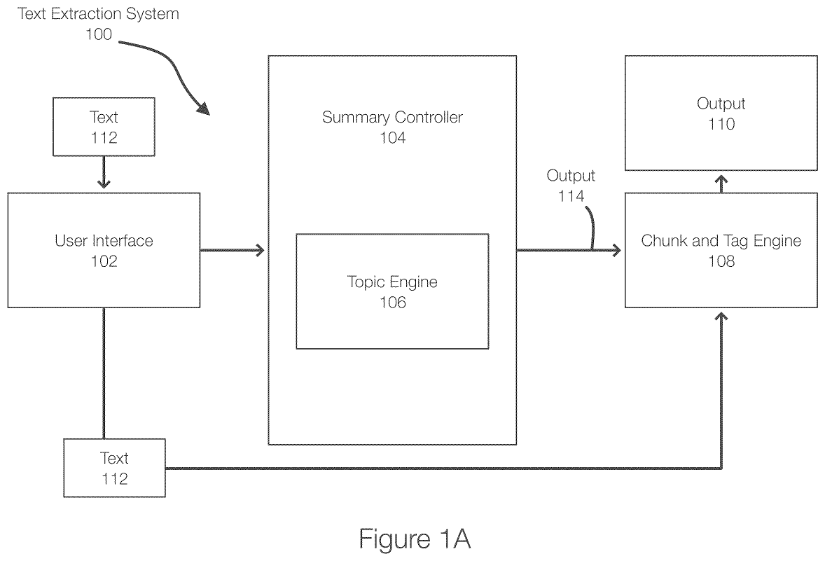

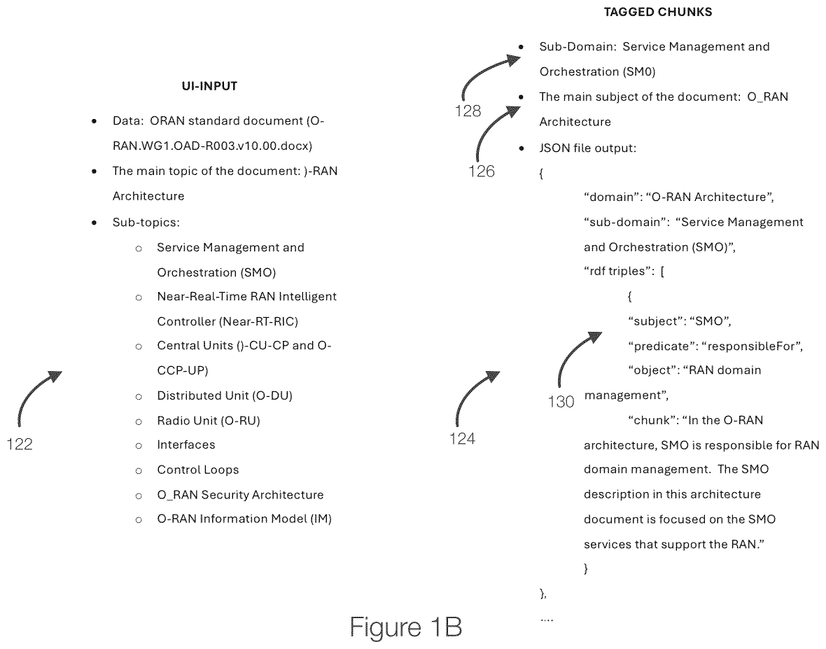

FIG. 1A discloses aspects of extracting text from a source. FIG. 1A illustrates an example of text extraction system 100 (system 100). In one example, text 112 (e.g., a document or other source or portion thereof) is input to the system 100 via a user interface 102. The text 112 is provided to a summary controller 104 that includes a topic engine 106. Thee topic engine 106 may include a large language model (LLM) configured to identify and summarize main topics and sub-topics included in the text 112. Thus, the response or output 114 of the topic engine 106 (or summary controller 104) may include main topics and sub-topics of the text 112.

The text 112 and the output 114 of the topic engine 106 are provided to the chunk and tag engine 108 (engine 108). The engine 108 may include an LLM configured to craft triples (subject, predicate, object) from the text 112 based on context, which may include the main topics and sub-topics of a domain identified by the topic engine 106 and included in the output 114 and the text 112. The context may also include chunks included in the extracted text. In one example, the output 110 of the engine 108 may include tagged chunks or tagged text. The output 110 may be a source of triples (a set of triples) that may be evaluated for inclusion in an ontology.

FIG. 1B discloses aspects of generating tagged chunks from user input. FIG. 1B illustrates text 122, which is an example of the text 112, that may be input to the system 100 via the user interface 102 to the summary controller 104. The topic engine 106 may receive the text 122. The text 122 may be used to prompt an LLM and the response of the LLM may include a main topic or domain (e.g., main domain 126) and/or sub-topics or sub-domains (e.g., sub-domain 128).

The engine 108 is configured to generate a triple 130 (or multiple triples) from the text 122 and the context. The context may include the domain 126 and/or sub-domain 128 generated by the summary controller 104 and/or the text 122 or chunks therein. In this example, the extracted text 124 is an example of the output 110 of the system 100. The extracted text 124 or portions thereof may be stored in a node database.

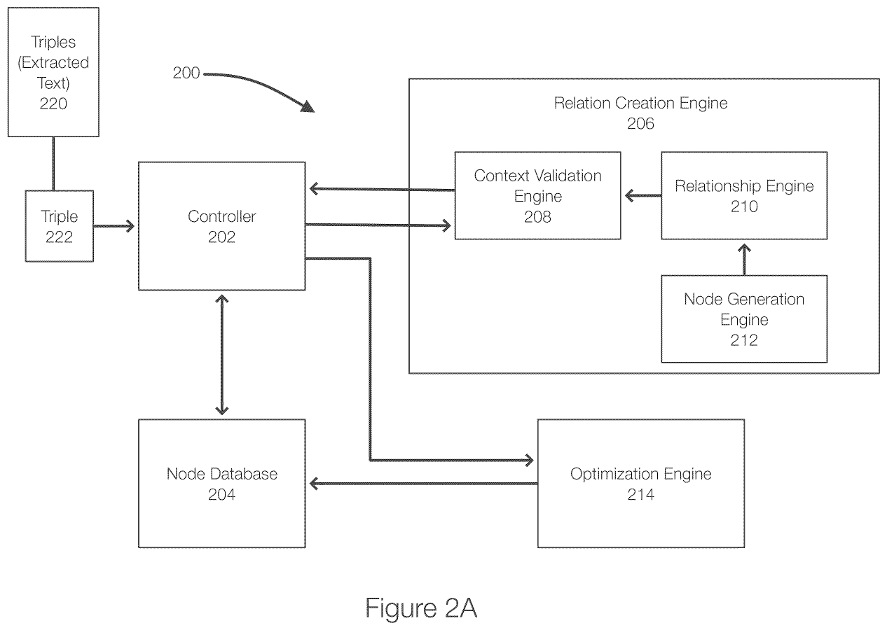

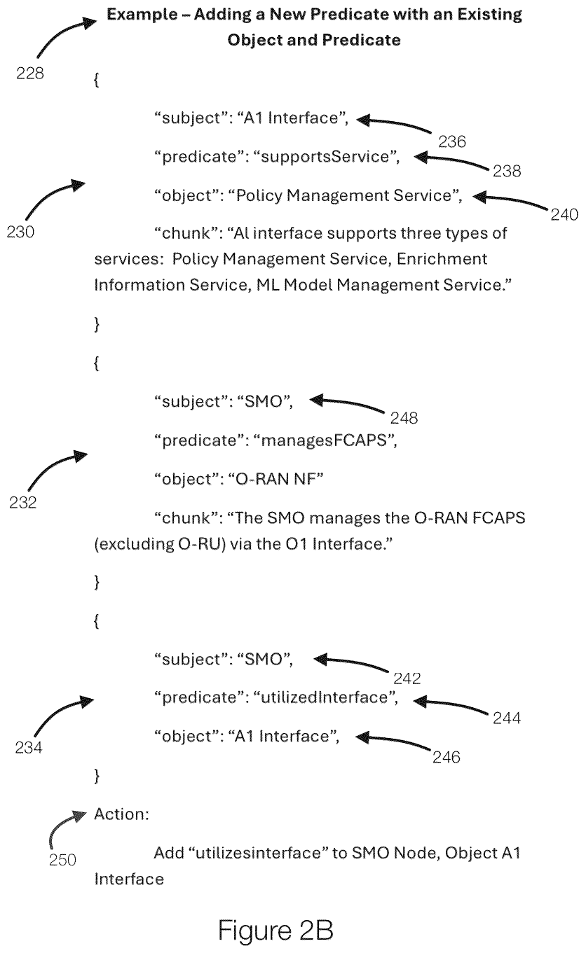

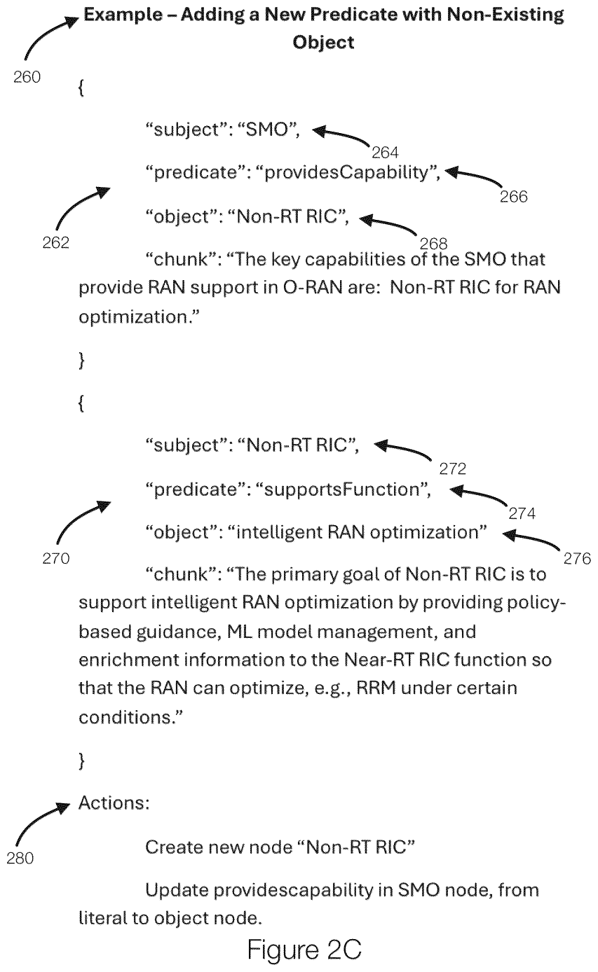

FIGS. 2A-2C discloses aspects of creating nodes based on triples. In one example, any nodes to be created or augmented by embodiments of the invention may not be actually included in an ontology until validated. However, nodes/relationships may be created during the creation process as needed to perform other tasks.

FIG. 2A discloses aspects of augmenting and/or creating ontology nodes. FIG. 2A illustrates a relation creation system 200 (system 200) configured to augment and/or create ontology nodes. Creating ontology nodes may include one or more of creating subject nodes, object nodes, and/or relationships between nodes. In this example, a node database 204 included in or accessible by the system 200 may store nodes of an ontology or the ontology itself. A controller 202 of the system 200 may have access to triples 220, or the extracted text generated by the system 100.

The system 200 may be configured to evaluate the triples 220 and generate additional nodes and/or augment existing nodes in the node database. In one example, a controller 202 may check for the availability of a triple in the triples 220. The triples 220 may represent or includes nodes for inclusion in the node database 204. More specifically, the triples 220 are processed to generate new nodes for the node database 204 or to augment existing nodes in the node database 204.

In this example, a triple 222 is available for processing by the system 200. The triple 222 may include each of a subject predicate, and an object. The triple 222, which may also include chunks or extracted text and the controller 202 may also receive the chunks and other data in the extracted text.

The triple 222 is evaluated to determine whether nodes in the ontology or in the node database 204 need to be created or updated. More specifically in one example, the subject(S) of the triple 222 may be used to determine whether a subject node exists in the node database 204. If the subject node for the triple 222 is not present in the node database 204, the subject node for the subject of the triple 222 is created.

In one example, determining whether a subject node exists for the subject of the triple 222 is performed semantically. This may be achieved, in one example, using embeddings to determine whether a subject node for the subject of the triple 222 is present in the node database 204. The object (O) of the triple 222 may be similarly evaluated to determine whether an object node for the object of the triple 222 exists in the node database 204.

Next, a predicate relationship (P), based on the predicate in the triple 222, is established between the subject node and the object node if the object node exists as a node in the node database 204. If the predicate included in the triple 222 serves as a predicate for a literal, the object node is a literal (e.g., a specific value such as a date, a number, or other data type). As previously stated, a literal node may be created in the node database 204. If an object node does not exist, the object node may be created prior to creating or establishing the relationship.

In some examples, even if the subject node and the object node exist in the node database 204, the predicate included in the triple 222 may not be present in the node database 204. In one example, the relation creation engine 206 is used to create a relationship or other aspect of the ontology including nodes based on the triple 222 and/or the associated chunks. In one example, the relation creation engine 206 may include various engines that are each configured for a different purpose.

For example, the relationship engine 210 is configured to generate a relationship. More specifically, the relationship engine 210 may include an LLM configured or fine-tuned to determine whether the predicate in the triple 222 should be a relationship between nodes or between a node and a literal. This may be based on the extracted text associated with the triple 222. The relationship engine 210, for example, can evaluate the object in the triple 222 and determine whether the object is more likely to be a literal (e.g., a value, or data) or a sub-class or sub-category.

In one example, the LLM of the relationship engine 210 may analyze the extracted text (e.g., domain, sub-domain, chunks) associated with the triple 222 to determine a nature of the predicate. The relationship engine 210 determines whether the predicate should represent a relationship between two nodes (entities) or between a node and a literal (attribute or value). The relationship engine 210 uses its understanding of the context to make this determination. The relationship engine 210 considers the semantics of the text and the roles of the entities involved. Based on the analysis, the relationship engine 210 generates an appropriate predicate that accurately reflects the relationship or attribute described in the text. The LLM of the relationship engine 210 may be fine-tuned on a specific dataset related to the domain of interest. This dataset may include examples of triples with predicates that represent relationships between nodes and between nodes and literals.

The node generation engine 212 is configured to generate a node when necessary (e.g., a subject node, an object node). More specifically in one example, the relationship engine 210 is configured to determine whether a predicate should be a relationship between nodes (e.g., a subject node and an object node) or between a subject node and a literal object. If necessary, the node generation engine 212 is configured to generate a suitable object node for the predicate.

The node generation engine 212 may include an LLM that is configured or fine-tuned to generate object nodes or literals based on the extracted text of the triple 222. In one example, the node generation engine 212 generates a node and the relationship engine 210 may determine whether the node is an object node or a literal.

The combination of pre-training and fine-tuning allows the LLM of the node generation engine 212 to effectively generate nodes that are contextually relevant and semantically accurate. For example, a triple may include the following:
Subject: “Albert Einstein”
Predicate: “discovered”
Object: “Theory of Relativity”

Inputting the triple into the node generation engines as a prompt may result in the creation of nodes. For example, the node generation engine may generate nodes for “Albert Einstein” (subject node) and “Theory of Relativity” (object node). In addition, the node generation engine is configured or trained to understand that “discovered” is a relationship between the subject node “Albert Einstein” and the object node “Theory of Relativity”. The node generation engine 212 ensures that the generated nodes are accurate and relevant to the context of the triple.

The context validation engine 208 is configured to validate the nodes, and/or the relationship generated in the relation creation engine 206. In one example, the context validation engine 208 is configured to validate the new relationship (subject node, relationship, object node). More specifically in one example, the context validation engine 208 interprets the triple (subject node, relationship, object node) to understand the context and the specific relationship being validated. Next, the context validation engine 208 analyzes the context to ensure that the relationship makes sense within the given domain.

In one example, this may include or involve:
Consistency Check: Verifying that the relationship is consistent with known facts and data; and
Relevance Check: Ensuring that the relationship is relevant and appropriate for the subject and object nodes.

If the validation performed by the context validation engine 208 fails, adjustments may be performed to the triple 222 and the relation creation operation may be repeated. Adjustments, by way of example only, may include correcting factual errors (e.g., correcting any inaccuracies in the information provided), providing more specificity (e.g., making the relationship more specific or precise to better reflect the intended meaning), providing clarity (e.g., rephrasing the relationship to ensure that the is clear and unambiguous), and/or rejecting the new or proposed entry.

Once the relationship is validated by the context validation engine 208, the result (e.g., subject node, relationship, and/or object node) is provided to the controller 202. For example, the context validation engine 208 may be trained with or have access to source material of the relevant domain.

For example, validating the relation (or node) may include receiving the relationship and submitting the relationship to an LLM to determine whether the relationship is valid and acceptable for inclusion in the ontology. In one example, the LLM may be able to determine whether the new relation is valid, true, or the like in the context of the domain, for example by comparing the entry to source documents of the domain, based on training, or the like.

For example, an entity that sells computing hardware, software, cloud-services, or the like may build or construct an ontology whose domain is computing systems and services. The LLM of the context validation engine 208 may include or have access to a knowledge base (and/or other sources) that stores computing standards, product documentation, white papers, or the like. This information allows the LLM of the context validation engine 208 to validate the relationship and/or node(s) being created/augmented.

The controller 202 may coordinate with an optimization engine 214 configured to enhance the relationship created/augmented by the relation creation engine 206. In one example, the optimization engine 214 may perform optimizations such as consistency optimizations, which may include aligning the relationship with existing data and standards to maintain consistency across the ontology, and clarity optimizations, which may include making the relationship more clear or more unambiguous to avoid or reduce misinterpretations.

When completed, the node database 204 is updated with the new information (e.g., a new/augmented subject node, object node, and/or relationship).

FIG. 2B discloses aspects of examples for creating and/or augmenting nodes in a node database or in an ontology. In particular, FIG. 2B illustrates an example 228 of adding a new predicate to a node database (e.g., the node database 204). FIG. 2B also illustrates examples 230 and 232, which exist in the node database 204. Thus, the example 230 is associated with a subject node 236, a predicate 238, and an object node 240. The examples 230 and 232 represents, in one example, relationships or entries, such as the entries or relationships being created by embodiments of the invention.

FIG. 2B also illustrates an example of a triple 234 that is being processed by the system 200. The triple 234 is associated with a subject(S) 242, a predicate (P) 244, and an object (O) 246. In this example, the node database may be searched semantically for the subject node 242. The search determines that that subject 242 is already present in the node database as the subject node 248 in the example 232. As a result, the subject node for the subject 242 of the triplet 234 does not need to be created.

Next, it is determined that the object 246 of the triplet 234 also exists as the subject node 236 in the example 230. Thus, in this example, the subject node 236 may augmented to be an object node (not a literal in this example).

The predicate 244 of the triplet 234, in this example, is not present in the node database 204. As a result, the relation creation engine 206 is used to determine whether the predicate 244 should be a relationship between the node 248 and the node 236 in the node database 204. The relationship engine 210 includes an LLM that is configured to determine whether the predicate 244 should be a relationship. If necessary (e.g., assuming that the object 246 is not present in the node database 204), the node generation engine 212 may create or generate a suitable object node for the relationship being created or augmented.

After the relationship engine 210 determines that the predicate 244 should be a relationship between the nodes 248 and 236, the context validation engine 208 may validate the relationship. If the context validation engine 208 fails the validation, adjustments may be made (e.g., to the subject, predicate, and/or object of the triple) and the relation operation may be repeated. Once the relationship is validated by the context validation engine 208, the new entry is submitted to the optimization engine 214 by the controller 202. Once optimized, the new relationship is added to the node database 204. More specifically, the predicate 244 is added to a relationship, which relates the node 248 to the node 236 via a predicate. The node database thus includes a relationship between the subject node 248 and the object node 236. The node 236 is augmented and is both a subject node and an object node.

FIG. 2C discloses aspects of creating and/or augmenting nodes in an ontology. In this instance, FIG. 2C illustrates an example 260 of adding a new predicate to an object node that does not exist in the node database 204. FIG. 2C illustrates an example 262 and a triple 270 being considered by the system 200. The example 262 includes a subject node 264, a predicate 266, and an object node 268. The triple 270 includes a subject 272, a predicate 274, and an object 276.

In this example, the subject 272 does not exist in the node database 204 (e.g., not in the example 262 as a subject node). However, the subject 272 exists as an object node 268 (currently a literal). Thus, a subject node for the subject 272 is created. More specifically, the object node 268 is also identified as a subject node in one example.

The predicate 274 is not present in the node database 204 in this example. In addition, the object 276 is not present in the node database 204 as an object node. Thus, the node generation engine 212 may generate an object node for the object 276. The relation creation engine 206 then creates the relationship for the predicate 274.

In this example, the controller 202 thus performs or orchestrates actions 280 that include the creation of a new node for the subject 272 (e.g., causing the object node 268 to be identified as a subject node). The actions 280 may also include creating an object node for the object 276 and adding the predicate 274 as a relationship between the node 268 and the newly created object node for the object 276. In addition, the relationship 266 is updated to an object node because the object node 268 is no longer a literal in view of the triplet 270 and new relationship generated from the triple 270.

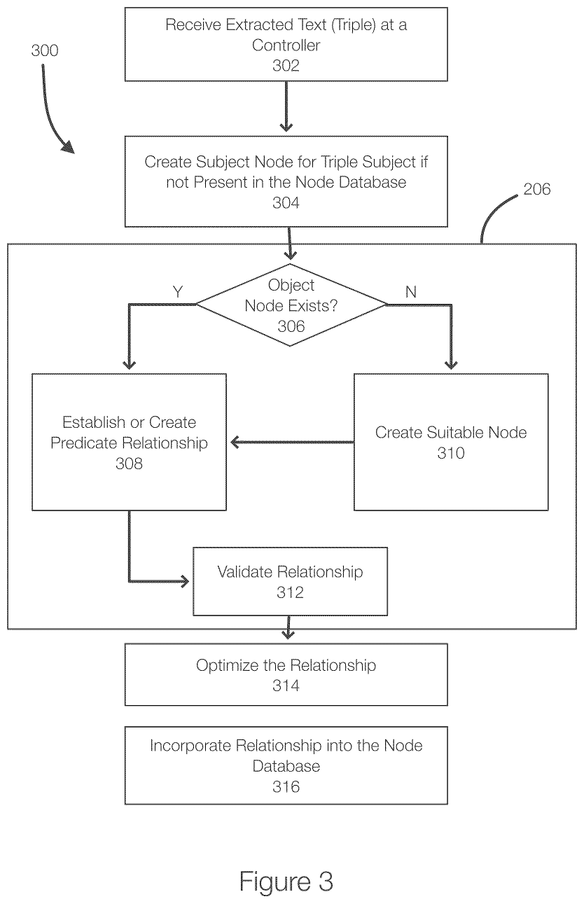

FIG. 3 discloses aspects of a method for creating and/or augmenting entries in an ontology or nodes of a node database. The method 300 includes receiving 203 extracted text (including the triple) at a controller of a system, such as the system 200. The triple may include a subject, predicate, object, and or text (e.g., a chunk). The method 300 includes creating 302 a subject node for the triple's subject when a subject node is not present in the node database (or the ontology).

Next, a relationship is created 316 by a relation creation engine 206. Creating 316 a relationship to include in the node database or in the ontology may be performed when an object node corresponding to the object of the triple exists (Y at 306) or does not exist (N at 306). In one example, when the object node does not exist (N at 306), a suitable node is created 310. Creating 310 a suitable node may include at least one of creating a literal for the predicate, creating a new object node that is not present in the node database, and/or augmenting an existing node (e.g., causing an existing subject node to also be an object node).

Next, a predicate relationship is created based on the predicate (and/or the chunk of text). The predicate included in the triple and/or context (e.g., domain, sub-domain, chunk) may be input to an LLM configured to respond with a relationship. The LLM may be trained on the domain or have access to source documents, or use the context to generate the response. More specifically, creating the relationship may include the LLM determining whether the predict should relate the subject node to the object node.

Once the relationship is generated, the relationship (and/or associated nodes) created by the LLM is validated 312, with the LLM or another suitable configured LLM. The LLM performing the validation may be configured to determine if the relationship is true or factual, based on the existing ontology, source documents of the domain, LLM training, or the like.

Once validated, the relationship may be optimized 314 by an LLM configured to optimize the relation and then included in or incorporated 316 into the node database (the ontology).

Embodiments of the invention are configured to democratize ontology creation/augmentation. Embodiments of the invention allow for wider access and wider participation. LLM-based operations ensure that ontologies are able to more effectively stay current with changes and dynamically adapt. Embodiments of the invention enhance node accuracy and enforce rigorous validation standard through LLM direct mitigation.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, ontology management operations, creating and/or augmenting subject nodes, predicates, relationships, and/or object nodes, validation operations, relationship operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any emodiment.

As used herein, the term ‘data’ or ‘object’ is intended to be broad in scope. Example embodiments are applicable to any system capable of storing and handling various types of objects, in analog, digital, or other form. Further, the AFMs, GNNs, LLMs, and other models may be trained with historical and/or synthetic data.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving a triple at a controller of a relation creation engine configured to create and/or augment nodes of an ontology stored in a node database, wherein the triple includes a subject, a predicate, and an object, creating a relationship between a subject node and an object node based on the triple, wherein creating the relationship includes determining that the predicate relates the subject node to the object node, validating the relationship by a context validation engine configured to determine whether the relationship is valid for including in the ontology, and including the relationship in the node database.

Embodiment 2. The method of embodiment 1, further comprising extracting text at the controller, wherein the extracted text includes the triple and a chunk of text.
Embodiment 3. The method of embodiment 1 and/or 2, further comprising creating the subject node when the subject node does not exist in the node database.
Embodiment 4. The method of embodiment 1, 2, and/or 3, further comprising generating, by a node generation engine that includes a first large language model, the object node when the object node does not exist in the node database.
Embodiment 5. The method of embodiment 1, 2, 3, and/or 4, further comprising submitting the predicate to a large language model configured to determine whether the subject node and the object node are related by the predicate.
Embodiment 6. The method of embodiment 1, 2, 3, 4, and/or 5, further comprising validating, by a context validation engine comprising a second large language model, the relationship, wherein the context validation engine is configured to determine whether the relationship is valid.
Embodiment 7. The method of embodiment 1, 2, 3, 4, 5, and/or 6, further comprising revising the triple when validation of the relationship fails and retrying the validation.
Embodiment 8. The method of embodiment 1, 2, 3, 4, 5, 6, and/or 7, further comprising optimizing the relationship.
Embodiment 9. The method of embodiment 1, 2, 3, 4, 5, 6, 7, and/or 8, further comprising including the relationship in the node database.

Embodiment 10. The method of embodiment 1, 2, 3, 4, 5, 6, 7, 8, and/or 9, further comprising one or more of: adding the subject node to the node database when the subject node did not exist in the node database, causing an existing subject node to be the object node, causing an existing object node to be the subject node, creating a relationship between the subject node and the object node in the node database, and/or creating a literal in the node database.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

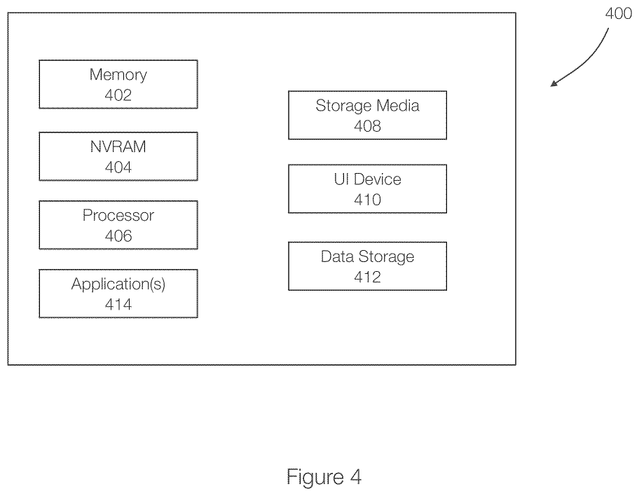

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

The device 400 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 400 may also represent a physical or virtual machine or server, an edge-based computing system, a cloud-based computing system, server clusters or other computing systems or environments. The device 400 may also represent multiple machines or devices, whether virtual, containerized, or physical. The device 400 may perform or execute steps or acts of the methods illustrated in the Figures.

The device 400 may represent a cloud-based system, an edge-based, system, an on-premise system, or combinations thereof. The device 400 may be a computing system that is distributed geographically.

The described embodiments are to be considered in all respects only as illustrative and not restrictive. All changes which come within the meaning and range of equivalency of the claims are to be embraced within their scope.

1. A method comprising:
receiving a triple at a controller of a relation creation engine configured to create and/or augment nodes of an ontology stored in a node database, wherein the triple includes a subject, a predicate, and an object;
determining whether a subject node corresponding to the subject exists in the node database using semantic analysis, and creating the subject node when the subject node does not exist in the node database;
determining, by a relationship engine comprising a first large language model and using context associated with the triple, whether the predicate represents (i) a relationship between two ontology nodes or (ii) a relationship between a subject node and a literal;
when the predicate represents a relationship between two ontology nodes, determining whether an object node corresponding to the object exists in the node database and generating the object node using a node generation engine comprising the first large language model when the object node does not exist in the node database;
when the predicate represents a relationship between the subject node and a literal, creating a literal corresponding to the object and associating the literal with the subject node via the predicate;
creating a relationship between a subject node and an object node based on the triple, wherein creating the relationship includes determining that the predicate relates the subject node to the object node;
validating the relationship by a context validation engine comprising a second large language model configured to evaluate semantic consistency and domain relevance of the relationship with respect to the ontology determine whether the relationship is valid for including in the ontology; and
optimizing the relationship to align with existing ontology structures prior to including the relationship in the node database.

2. The method of claim 1, further comprising extracting text at the controller, wherein the extracted text includes the triple and a chunk of text.

3. The method of claim 1, further comprising creating the subject node when the subject node does not exist in the node database.

4. The method of claim 1, further comprising generating, by a node generation engine that includes a first large language model, the object node when the object node does not exist in the node database.

5. The method of claim 1, further comprising submitting the predicate to a large language model configured to determine whether the subject node and the object node are related by the predicate.

6. The method of claim 5, further comprising validating, by a context validation engine comprising a second large language model, the relationship, wherein the context validation engine is configured to determine whether the relationship is valid.

7. The method of claim 6, further comprising revising the triple when validation of the relationship fails and retrying the validation.

8. The method of claim 7, further comprising optimizing the relationship.

9. The method of claim 8, further comprising including the relationship in the node database.

10. The method of claim 9, further comprising one or more of:
adding the subject node to the node database when the subject node did not exist in the node database;
causing an existing subject node to be the object node;
causing an existing object node to be the subject node;
creating a relationship between the subject node and the object node in the node database; and/or
creating a literal in the node database.

11. A non-transitory storage medium having stored therein instructions that are executable by one or more hardware processors to perform operations comprising:
receiving a triple at a controller of a relation creation engine configured to create and/or augment nodes of an ontology stored in a node database, wherein the triple includes a subject, a predicate, and an object;
determining whether a subject node corresponding to the subject exists in the node database using semantic analysis, and creating the subject node when the subject node does not exist in the node database;
determining, by a relationship engine comprising a first large language model and using context associated with the triple, whether the predicate represents (i) a relationship between two ontology nodes or (ii) a relationship between a subject node and a literal;
when the predicate represents a relationship between two ontology nodes, determining whether an object node corresponding to the object exists in the node database and generating the object node using a node generation engine comprising the first large language model when the object node does not exist in the node database;
when the predicate represents a relationship between the subject node and a literal, creating a literal corresponding to the object and associating the literal with the subject node via the predicate;
creating a relationship between a subject node and an object node based on the triple, wherein creating the relationship includes determining that the predicate relates the subject node to the object node;
validating the relationship by a context validation engine comprising a second large language model configured to evaluate semantic consistency and domain relevance of the relationship with respect to the ontology determine whether the relationship is valid for including in the ontology; and
optimizing the relationship to align with existing ontology structures prior to including the relationship in the node database.

12. The non-transitory storage medium of claim 11, further comprising extracting text at the controller, wherein the extracted text includes the triple and a chunk of text.

13. The non-transitory storage medium of claim 11, further comprising creating the subject node when the subject node does not exist in the node database.

14. The non-transitory storage medium of claim 11, further comprising generating, by a node generation engine that includes a first large language model, the object node when the object node does not exist in the node database.

15. The non-transitory storage medium of claim 11, further comprising submitting the predicate to a large language model configured to determine whether the subject node and the object node are related by the predicate.

16. The non-transitory storage medium of claim 15, further comprising validating, by a context validation engine comprising a second large language model, the relationship, wherein the context validation engine is configured to determine whether the relationship is valid.

17. The non-transitory storage medium of claim 16, further comprising revising the triple when validation of the relationship fails and retrying the validation.

18. The non-transitory storage medium of claim 17, further comprising optimizing the relationship.

19. The non-transitory storage medium of claim 18, further comprising including the relationship in the node database.

20. The non-transitory storage medium of claim 19, further comprising one or more of:
adding the subject node to the node database when the subject node did not exist in the node database;
causing an existing subject node to be the object node;
causing an existing object node to be the subject node;
creating a relationship between the subject node and the object node in the node database; and/or
creating a literal in the node database.
